(19) United States
(12) Patent Application Publication
(10) Pub. No.: US 2009/0063833 A1
(43) Pub. Date: Mar. 5, 2009

(54) BOOTLESS ACTIVATION

(75) Inventor: Sammy X. HO, Reston, VA (US)

Correspondence Address: SUGHRUE MION, PLLC, 2100 PENNSYLVANIA AVENUE, N.W., SUITE 800, WASHINGTON, DC, 20037, US

(73) Assignee: NEXT GENERATION BROADBAND, Washington, DC (US)

(21) Appl. No.: 12/270,058

(22) Filed: Nov. 13, 2008

Related U.S. Application Data
(62) Division of application No. 11/427,024, filed on Jun. 28, 2006.
(60) Provisional application No. 60/694,686, filed on Jun. 29, 2005.

(51) Int. Cl. G06F 15/177

(52) U.S. Cl. 713/1

(57) ABSTRACT

In an Internet Protocol (IP) based network having a distributed end devices that receive their respective IP routing and device specific configuration information from a central location using dynamic host configuration protocol (DHCP) and other related protocols, bootless activation enables the network operator to dynamically control and automatically switch an end device on an individual or group basis from one peer IP network to another peer IP network without requiring an individual user to manually reboot or reset the respective distributed end device. Examples of IP networks include broadband networks such as cable modem, fiber-based and digital subscriber line (DSL) network; wireless IP based networks; and IP based metropolitan networks; and local area networks and multiple site enterprise networks.

### CROSS-REFERENCE TO RELATED APPLICATIONS

This application is a Divisional of application Ser. No. 11/427,024 filed Jun. 28, 2006 which claims priority under 35 U.S.C. § 119(e) from Provisional U.S. Application No. 60/694,686, filed on Jun. 29, 2005. The entire disclosures of the prior applications, application Ser. Nos. 11/427,024 and 60/694,686 are considered part of the disclosure of the accompanying divisional application and are hereby incorporated by reference.

### BACKGROUND OF THE INVENTION

1. Technical Field

Aspects of the present invention relate to a system and method for switching an end device from a first subnetwork to a second subnetwork, and more specifically, a system and method for switching the end device from the first subnetwork to the second subnetwork without requiring the end user to manually reset or restart the end device.

2. Related Art

In related art large networks, many end points are distributed throughout a large number of locations, and the network operator must rely on the end user to perform and complete various installation and maintenance activities. However, some end users may find tasks such rebooting or restarting network equipment cumbersome, time consuming and unduly complex.

In the related art activation process, network operators place un-registered end devices in an isolated peer network. The isolated peer network includes a central peer network or a sub-network where only limited network-based services or functions may be accessed.

In a related art isolated peer network, an end device cannot route internet protocol (IP) traffic to central applications such as email, or access the Internet. The network operator directs end devices to an isolated peer network or sub-network by providing the end device at the time the network requests the IP address of the end device, with IP address and end device-specific configuration information such as the location of DNS (domain name system) servers and IP gateway router addresses that route IP traffic to a specific sub-network. The end device may exit the isolated peer network only by having the DHCP (Dynamic Host Configuration Protocol) server issue a new IP address and configuration information.

In the related art, the end device may only receive a new IP address from a DHCP server or equivalent configuration server at a time of its choosing by manually releasing and renewing the IP address. This task may be done through the end user device's operating system, or by re-cycling its power. In the related art, this activity may only be activated by: (a) having client software that either is controlled remotely by the operator (for example but not by way of limitation, by an SNMP (simple network management protocol) client, or (b) a software program that is preloaded or pre-installed on the end device, and is configured to perform this task directly.

### SUMMARY OF THE INVENTION

Accordingly, various exemplary embodiments provide bootless activation, which simplifies the process that network operators must use to switch an end user from one peer IP network to another. In addition, bootless activation enables an end user to be switched from one peer IP network to another peer IP network without the end user being required to manually reset or restart one or more end devices, or being required to install client software on the end device to perform the task of resetting or restarting the end device.

Bootless activation according to the exemplary embodiments has various advantages, although these advantages are not required for the exemplary embodiments to be enabled. For example, but not by way of limitation, bootless activation may completely remove the need for client software on end device, or the requirement that the end user must recycle power. Additionally, bootless activation may substantially simplify the end user's experience by making the transition from one sub-network to another transparent to end user, and speeding up the overall process by removing the time-consuming task of powering down and powering up a device from the overall service activation process.

### BRIEF DESCRIPTION OF THE DRAWINGS

Exemplary embodiments will be more apparent from the following detailed description taken in conjunction with the accompanying drawings, in which:

FIG. 1 illustrates an IP network according to an exemplary, non-limiting embodiment; and

FIG. 2 illustrates an IP network according to another exemplary, non-limiting embodiment.

### DETAILED DESCRIPTION OF THE EXEMPLARY EMBODIMENTS

Hereinafter, exemplary embodiments will be described in detail with reference to the accompanying drawings. The aspects and features of the present invention and methods for achieving the aspects and features will be apparent by referring to the embodiments to be described in detail with reference to the accompanying drawings. However, the present invention is not limited to the exemplary embodiments disclosed hereinafter, but will be implemented in diverse forms. The matters defined in the description, such as the detailed construction and elements, are nothing but specific details provided to assist those of ordinary skill in the art in a comprehensive understanding of the exemplary embodiments, as defined within the scope of appended claims. In the detailed description, the same drawing reference numerals are used for the same elements across various figures.

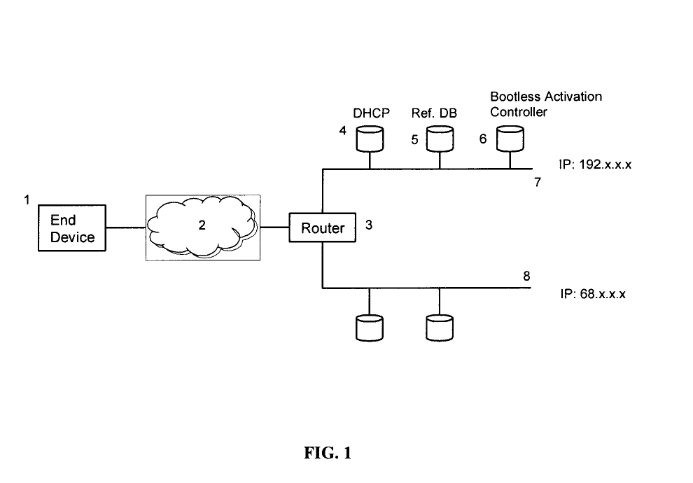

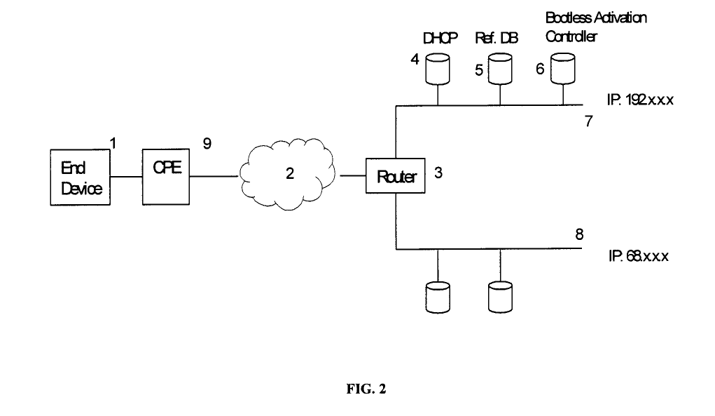

In an IP network that receives an IP address from a DHCP or equivalent configuration server as would be understood by one skilled in the art, all end devices on the network are configured to receive their respective IP addresses and equipment-specific configuration data from a central point in the network. FIG. 1 and FIG. 2 each illustrate an exemplary embodiment of these networks.

In FIG. 1, the end device 1 is connected to the larger network through an IP routed access network 2. The access network 2 includes IP based routers and other IP network devices capable of routing IP traffic. Examples include but are not limited to IP routers, DSLAMs (digital subscriber line access multiplexer), Cable Modem Termination Systems, and FTTx (fiber to the “x”, where x is, for example but not by way of limitation, a home) network devices.

The access network 2 connects one or many remote sites and end users to a central location that provides data center services. The central location can include one or more networks that can be reached by the end user through a border router 3 in core of the network 2. The border router controls how IP traffic is routed in the core of the network.

FIGS. 1 and 2 each illustrate sub-networks 7 and 8. Once an end user has access to a sub-network, that user can reach application services such on that network. Applications may include (but are not limited to) network applications, web content, email, Internet access, and the like. In addition, sub-networks are also located a central site or data center.

In the bootless activation system according to the exemplary embodiment, at least the following operations are performed:

1. The end device 1 requests an IP address. The IP address request travels across access network 2 and reaches the border router 3.

2. The boarder router 3 is configured to relay all DHCP requests to first sub-network 7.

3. The DHCP Server 4 examines the request, culls out an identifier address, such as the physical or MAC (media access control) sublayer address of the end device 1, and checks the physical or MAC address against a reference database 5. The reference database 5 maintains a record of access permissions for the End Device 1. Examples of reference database 5 include (but are not limited to) an LDAP (lightweight directory access protocol) directory or a RADIUS (remote authentication dial-in user service) server. However, a different reference database 5 may be used, as would be understood by one skilled in the art.

4. If the end device 1 has permission to access a centrally located application and/or service, the end device 1 is provided with an IP address that may be routed to second IP network 8. In this example, first sub-network 7 is a private IP address. The DHCP is configured to provide the end device 1 with an IP address with a substantially short lease time, thereby requiring the end device 1 to request a new address on a frequent basis.

5. If the end device is not permitted access second sub-network 8, the end device 1 is provided with a private IP address, where traffic can only be routed to the first sub-network 7. At this point, the end user may be requested by a special application server, such as a self registration server, to apply for access to network or a customer care application that requests that the end user to perform a specific action. After the end user performs the required task, the bootless activation controller 6 sends instructions to the reference database 5 to enable the end user to access second sub-network 8.

6. When the lease time is at a prescribed time with respect to its expiration (for example, but not by way of limitation, about half or 50% of the lease time for this exemplary embodiment), the end device 1 requests permission to renew the IP address. If the end device 1, based on the business rules, is required to remain in its sub-network, the IP address is renewed. For example but not by way of limitation, if the end user has not completed a self-registration process, the IP address will be renewed until the status of the end device is changed. When the status of the end device is changed in the reference database 5, for example (but not by way of limitation) if a self registration process is completed, then the end device 1 is ready to be placed on another sub-network.

When the end device 1 at this point (e.g., 50% of the total lease time) requests that its IP lease is renewed, the DHCP or equivalent configuration server rejects the request. In the case of the DHCP server, a NAK (i.e., message from server to client indicating an incorrect notion of a network message, or an expired lease) is returned. This rejection forces the end device to a request a new IP address. At that point, the process returns to operation 3 above, and the end device ultimately receives a new IP address and configuration, and is pointed towards the appropriate sub-network.

Since the end device 1 is requesting an IP address on frequent basis, when end device 1 receives a new IP address, its IP traffic can access all network-based application services, for example but not by way of limitation, Internet access, email, applications, etc.

In bootless activation, the DHCP 4 is forcing the end device to switch sub-networks without the user having to reboot the end device. The end user is instructed to wait a substantially short period before using the network service.

In a network where CPE (computer premise equipment) 9 is required to access the network and that CPE 9 is configured to receive an IP address via DHCP, the substantially same process as described above is used, with two exceptions:

a. CPE 9 receives an IP address from the same or different DHCP 4

b. The access network is configured such that the MAC address of the CPE 9 is embedded in the end device's 1 DHCP request. For example but not by way of limitation, DHCP Option 82 performs such as task.

CPE 9 is defined as device that interfaces the end device 1 to the network 2, such as cable modem or DSL modem.

Otherwise the substantially same process as described above is followed.

Examples of Bootless Activation

I. Cable Modem Service Activation

In a cable modem service network, bootless activation improves on the self install process by not requiring the end user to reboot their personal computer or end device when the self installation process is completed

In contrast, the related art process for self installation/auto installation of cable service requires the end user to perform the following operations:

A. Acquire a cable modem that is currently not registered on the cable modem service.

B. Connect the acquired cable modem to the cable system and personal computer. If the end user has a home networking router, the customer can connect a personal computer through the home network.

C. Register the cable modem with the service operator (it is assumed that the operator can support automatic or web-based registration). The cable operator system identifies the cable modem by its MAC address. When the cable modem requests an IP address, prior to issuing that DHCP, the cable operator's current system checks a reference data base such as LDAP. If the cable modem is not registered, the cable modem and any downstream equipment such as a personal computer are provided an IP address and configuration data that limits that personal computer IP traffic to a protected network, referred to above as the “walled garden” Once in the protected network, the user may only access a limited number of services.

D. The end user opens a web browser and is presented with self registration web page. The end user completes the web pages to set up an account.

E. After the user has successfully set up an account, then they are requested to reboot and start personal computer and all end devices downstream from the cable modem, so that the end device may receive new IP address and configuration data. The network operator may or may not reset the cable modem's IP address and configuration data.

F. When the user receives new IP address and configuration, they can use the full range of services available to all users.

Alternatively, some related art approaches require the end user to load an application program on their personal computer that would guide them through the same process. This program may or may not automatically reboot the end user's computer.

Bootless activation differs from the foregoing related art activation experience by not requiring the end user to reboot, restart or otherwise manually change the condition of their end devices such as personal computer, home networking or any other device downstream from the cable modem.

In bootless activation, the end user must proceed according to the following operations:

A. The install the cable modem

B. The end user is placed in the Walled Garden

C. The end user completes a self registration web page

After the self registration process is completed, the user is asked to wait a substantially short period. During that period:

i. The bootless activation controller 6 registers the cable modem on a network service and all user accounts are set and provisioned by the cable operator's provisioning or customer resource management system.

ii. The cable modem is reset and receives a new IP address.

iii. The personal computer and, if necessary, all home networking equipment, receives a new IP address from the DHCP server. This operation is necessary, because all end devices downstream from the cable modem are requesting a new IP address based on short lease time, so it appears to the user as if their computer is automatically reset. After the IP address is received, the user may access all available network services.

II. Bootless Activation for DSL and Other Broadband Technologies

The substantially same process described above for bootless activation for cable modem networks can be used for any IP-enabled network such as DSL, FTTx networks, or large corporate IP based services that use DHCP to provide IP addresses to their end point. The methods are substantially the same, though a different CPE may be used.

III. CPE Equipment Swap Out

In a broadband network, when CPE needs to be swapped out, the end user already has an account established. In a network that supports automatic installation, when an unregistered CPE is connected to that network, the end user's IP traffic is sent to a protected sub-network. While in the protected sub-network, the end user may access their account, activate the new CPE and deactivate the old CPE.

As described above, the automatic installation automatically reads the CPE's MAC address. The automatic installation then instructs the bootless activation controller 6 to update the reference database 5. When the IP address of the CPE 9 is renewed, the CPE 9 and all downstream end devices are provided with IP address(es) that enables them to access all of the broadband networks services, such as Internet access, email and other applications, but not limited thereto.

IV. System Migration

In a network with a large number of end points, selected users may be placed in dedicated, protected sub-network. For example but not by way of limitation, customers may be placed in a walled garden to force a customer to perform a specific action, such as paying a bill or downloading a software patch or new software application, or informing the end user that they are being transitioned to a new network service.

After the end user has performed the required task or activity, the end user must in turn be provided a new IP address and configuration data, so that IP traffic from that end device will be sent to the desired sub-network.

Without bootless activation, the end user would have to reboot or restart the end devices (e.g., 1) and the CPE 9. However, with bootless activation, the customer is requested to wait a short period of time, and the IP address is automatically renewed and the end user is transferred over to the desired network.

The foregoing operations of the exemplary embodiment may be stored as instructions in a computer-readable medium. For example, but not by way of limitation, the computer-readable medium may include (but it not limited to) an optical or magnetic media, an external storage device, a remote storage device, or any other computer-readable medium as would be understood by one skilled in the art. Further, the instructions may be distributed over a plurality of such computer-readable media located commonly or apart from each other.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of switching an access of an end device between a first subnetwork and a second subnetwork, comprising:
permitting said end device to access said first subnetwork and not permitting said end device to access said second subnetwork;
awaiting the performance of an action by a user of said end device;
when said user performs said action, registering said end device on a network service, and providing said end device with a new IP address of said second subnetwork via a bootless activation controller; and
permitting said user to access said second subnetwork via said new IP address, wherein and said IP address of said end device is periodically renewed at a substantially short time period.

2. The method of claim 1, further comprising installing computer premise equipment (CPE) positioned between said end device and said network.

3. The method of claim 2, wherein said CPE comprises one of a digital subscriber line (DSL) modem and a cable modem.

4. The method of claim 1, wherein said address identifier comprises at least one of a physical address and a (media access control) (MAC) address.

5. The method of claim 1, wherein said action performed by said end user comprises one of: (a) said end device applying for access to said second subnetwork, (b) replacing said CPE with another CPE while said end device is connected to said first subnetwork, and (c) making a payment online and installing software via said first subnetwork.

6. The method of claim 1, wherein said first subnetwork and said second subnetwork are at least one of digital subscriber line (DSL) networks and cable networks.
